(19) United States
(12) Patent Application Publication
(10) Pub. No.: US 2012/0162160 A1
(43) Pub. Date: Jun. 28, 2012

(54) Information Processing Apparatus, Display Processing Method, Program, and Storage Medium

(75) Inventors: Takehiko Amano, Tokyo (JP); Yoshio Horiuchi, Kanagawa (JP); Ken Kumagai, Kanagawa (JP)

(73) Assignee: INTERNATIONAL BUSINESS MACHINES CORPORATION, Armonk, NY (US)

(21) Appl. No.: 13/333,115

(22) Filed: Dec. 21, 2011

(30) Foreign Application Priority Data
Dec. 21, 2010 (JP) 2010-284435

(51) Int. Cl. G09G 5/00

(52) U.S. Cl. 345/204

(57) ABSTRACT

An information processing apparatus to run software is provided. The software includes, as a user interface, a display screen having many objects arranged thereon. The information processing apparatus includes a calculation unit, an extraction unit, and a display control unit.

### BACKGROUND

Embodiments of the present invention relate to a graphical user interface (hereafter referred to as a “GUI”). More specifically, embodiments of the invention relates to an information processing apparatus, a display processing method, a program, and a storage medium that can prevent a reduction in user convenience when handling many objects on the display screen.

Currently, many personal computers use a window system which can be operated intuitively. In a window system, the user can do tasks simultaneously while maintaining multiple windows on the desktop and changing the window using an input device such as a mouse or keyboard.

To simplify window control, a multi document interface (MDI) application or a tabbed document interface (TDI) application may be installed. These types of applications collectively control multiple child windows under a single parent window, which can avoid the desktop from overflowing with many windows.

While use of the MDI type or TDI type is advantageous in that child windows of the same application are collected, the area in which tabs for changing child windows can be arranged is limited on the application screen. Thus, user convenience may be reduced as will be described below.

Specifically, when many child windows are opened in the same application, objects such as tabs are densely packed in the above-mentioned limited area, reducing the area which can be allocated to each object. Thus, pieces of display text such as titles cannot be sufficiently displayed, and the labels of objects have the same text. As a result, the user may not be able to distinguish them from each other.

This problem applies to not only user interfaces for changing the child window in an application but also user interfaces for changing the window between applications, such as a task bar or task switcher. For example, in the Windows® task switch function, icons representing windows or child windows (hereafter may be collectively simply referred to as “windows”) are presented in an aligned manner. In this case, icons in the same application have the same appearance, becoming indistinguishable.

When the details of the objects cannot be grasped at a glance due to the same or similar appearance of the objects, the details can be grasped using tooltips or hover helps. A tooltip is a function of allowing a description prepared for an object to pop up, by pointing to the object with a mouse.

However, use of tooltips or the like requires repeating a task of pointing to each object with a mouse to check pop-up again and again. Otherwise, an object corresponding to the desired window cannot be reached. This is troublesome for the user. While a technique for displaying the tooltips of all objects can be used, disorderly display of the tooltips makes the display screen congested unexpectedly. This does not help grasp the details of the objects at a glance.

Japanese Unexamined Patent Application Publication No. 2007-58272 (Patent Literature 1) discloses an icon description display apparatus which is intended to access currently displayed icons quickly and easily. The apparatus according to Patent Literature 1 includes an icon information file storing, for each icon, a list of the name of the icon, the image thereof, and the description thereof, and the screen on which the icon is displayed. The icon description display apparatus displays icons on the screen and, each time the displayed screen is updated, refers to the icon information file and creates an actual icon list of icons displayed on the updated screen. It also monitors an input control unit and, when an icon description instruction is displayed, displays a list of the descriptions of icons currently displayed on the screen in accordance with the actual icon list.

However, since Patent Literature 1 is intended to display a list of the descriptions of icons currently displayed on the screen, the description list is expanded when many icons are displayed, making the display screen congested. This does not help grasp the details of the icons at a glance.

Windows® Aero (Non Patent Literature 1) provides the task bar preview function, which displays a reduced-size preview of a window when a task bar button is pointed to, and the task switch function, which displays a real-time preview of a window.

However, the task bar preview function is only a tooltip extension which displays a reduced preview of a window instead of the text of a tooltip. Accordingly, as in the use of tooltips, when many windows are opened, the desired button cannot be reached unless each task bar button is pointed to with a mouse to check previews. The task switch function requires a wide area to display previews effectively and does not originally address cases where many windows are opened. If many previews are arranged, the small previews have similar appearances and will be most probably indistinguishable.

To provide a function which can get a bird's eye view of all opened applications, Mac® OS X Lion Mission Control (Non Patent Literature 2) provides a function which, according to a user action, can group opened windows for each application and collectively display the grouped windows in the form of thumbnails or the like.

However, the technology of Patent Literature 2 only groups and displays windows of the same application and requires a wide area to display previews effectively. It is not originally intended to address cases where many windows are opened. If many previews are arranged, the small previews have similar appearances and will be highly probably indistinguishable.

Accordingly, if, in changing the window, it is possible to identify an object of the user's interest on the display screen and present the descriptions of windows or previews corresponding to a certain range of objects considered to have higher relatedness with the object of interest rather than simply obtaining the details of the currently opened all windows and uniformly presenting the details, user convenience is conceivably increased.

### CITATION LIST

### Patent Literature

[PTL 1] Japanese Unexamined Patent Application Publication No. 2007-58272

### Non Patent Literature

[NPL 1] “What is the Aero desktop experience” [online] [searched on Dec. 13, 2010], Internet <URL; http://windows.microsoft.com/ja-jP/windows7/What-is-the-Aero-desktop-exeperience>
[NPL 2] “Announcement of Mac OSX Lion,” [online], [searched on Dec. 13, 2010], Internet <URL; http://www.apple.com/jp/macosx/lion/>

### BRIEF SUMMARY

The present invention has been made in view of the above-mentioned problems. Accordingly, embodiments of the invention may provide an information processing apparatus, a display processing method, a program, and a storage medium that can present information desired by the user efficiently by extracting an object considered to be of the user's interest from among many objects arranged on the display screen and presenting information about the object and thus can favorably prevent a reduction in user convenience caused by the arrangement of many objects on the display screen.

To solve the above-mentioned problems with the related art, the present invention provides an information processing apparatus having the following features. First, this information processing apparatus calculates evaluation values of multiple objects such as tabs or icons arranged on a display screen provided as an interface by software running on the information processing apparatus. The evaluation values are obtained by evaluating the similarity between the objects and the distance on the display screen therebetween. Subsequently, when a particular operation event related to the display screen is generated using an input device, for example, when an operation event is generated on a particular object, the information processing apparatus extracts one or more objects whose evaluation value relative to an object of interest directly related to the event meets an extraction condition. It then displays respective pieces of presentation information prepared for these objects as a screen area closer to the user than the display screen on a display unit so that the pieces of presentation information are directly or indirectly visually associated with each other. The extraction condition is a condition for extracting related objects which are related to the object of the user's direct interest and which are highly required to be presented as candidates to the user.

According to the above-mentioned configuration, even when many objects are densely packed in the display area, whose size is generally limited, so that the objects have the same or similar appearance and are visually indistinguishable, a group of objects considered to be related to an object on which the user has generated an operation event by estimation are extracted. Then, pieces of information about these objects are presented to the user. Thus, the user can find the desired object efficiently.

According to an embodiment of the present invention, there is provided an information processing apparatus on which software runs, the software including a display screen as a user interface, the display screen having a plurality of objects arranged thereon. The information processing apparatus may comprise a calculation unit that calculates an evaluation value, the evaluation value being obtained by evaluating similarity between the objects and a distance on the display screen therebetween, an extraction unit that, in response to generation of an operation event related to the display screen using an input device, extracts one or more objects whose evaluation value relative to an object of interest directly related to the operation event meets an extraction condition, from the display screen as related objects, and a display control unit that displays respective pieces of presentation information prepared for the object of interest and the related objects as a screen area closer to a user than the display screen on a display unit so that the pieces of presentation information are visually associated with each other.

According to an embodiment of the present invention, there is provided a display processing method performed by an information processing apparatus on which software runs, the software including a display screen as a user interface, the display screen having a plurality of objects arranged thereon. The display processing method may comprise detecting an operation event related to the display screen generated by an input device, calculating respective evaluation values between an object of interest, the object of interest being one of the objects and directly related to the operation event, and the others of the objects, the evaluation values each being obtained by evaluating similarity between objects and a distance on the display screen therebetween, and extracting one or more objects whose evaluation value meets an extraction condition, as related objects; and displaying respective pieces of presentation information prepared for the object of interest and the related objects as a screen area closer to a user than the display screen on a display unit so that the pieces of presentation information are visually associated with each other.

According to another embodiment of the present invention, there is provided a computer readable storage medium comprising a set of instructions for realizing an information processing apparatus on which software runs, the software including a display screen as a user interface, the display screen having a plurality of objects arranged thereon, which, if executed by a processor, cause a computer to calculate an evaluation value, the evaluation value being obtained by evaluating similarity between objects and a distance on the display screen therebetween, extract, when an operation event related to the display screen is generated using an input device, one or more objects whose evaluation value relative to an object of interest directly related to the operation event meets an extraction condition, from the display screen as related objects, and display respective pieces of presentation information prepared for the object of interest and the related objects as a screen area closer to a user than the display screen on a display unit so that the pieces of presentation information are visually associated with each other.

### BRIEF DESCRIPTION OF THE SEVERAL VIEWS OF THE DRAWINGS

FIG. 1 is a diagram showing function blocks of a computer apparatus according to a first embodiment of the present invention.

FIG. 2 is a drawing illustrating an application window displayed on a display unit included in the computer apparatus in the first embodiment.

FIG. 3 is a diagram illustrating the data structure of tab data stored in a storage unit of the computer apparatus in the first embodiment.

FIG. 4 is a diagram illustrating the data structure of evaluation values calculated by an evaluation calculation unit in the first embodiment.

FIG. 5 is a flowchart showing a change support process performed by the computer apparatus according to the first embodiment.

FIG. 6 is a flowchart showing the change support process performed by the computer apparatus according to the first embodiment.

FIG. 7 illustrates an application window displayed on the display unit included in the computer apparatus in the first embodiment.

FIG. 8 illustrates the application window displayed on the display unit included in the computer apparatus in the first embodiment.

FIG. 9 illustrates the application window displayed on the display unit included in the computer apparatus in the first embodiment.

FIG. 10 illustrates function blocks of a computer apparatus according to a second embodiment of the present invention.

FIG. 11 illustrates a task switch screen displayed on a display unit included in the computer apparatus in the second embodiment.

### DETAILED DESCRIPTION

While the present invention will be described using embodiments, the invention is not limited thereto.

### First Embodiment

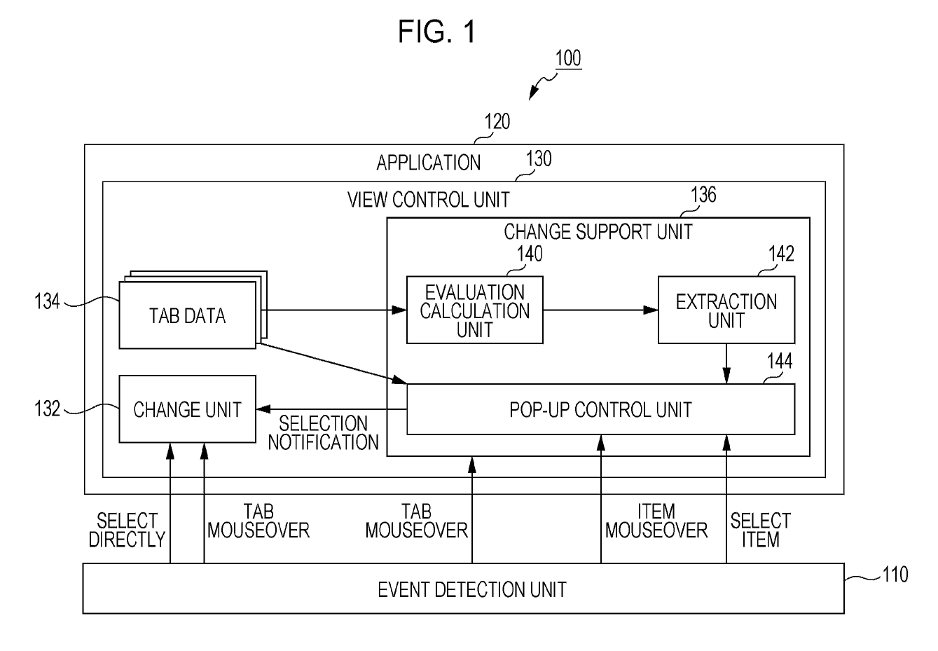

An information processing apparatus according to a first embodiment of the present invention will be described with reference to FIGS. 1 to 9. In the first embodiment, a computer apparatus which runs a tab browser will be described as an example of an information processing apparatus on which software runs, the software including as a user interface a display screen on which multiple objects are arranged.

FIG. 1 shows function blocks of a computer apparatus 100 according to the first embodiment. The computer apparatus 100 is mainly configured as personal computers, personal data assistance (PDA), mobile terminals, and the like, but is not limited thereto. The computer apparatus 100 includes a CPU and a RAM, as well as input devices, such as a mouse, a keyboard, and a touchpanel, and a display unit such as a display. It runs under the control of a GUI-based operating system such as Windows®, Linux®, or Mac® OS X.

The function blocks of the computer apparatus 100 shown in FIG. 1 include an event detection unit 110, which detects an operation event generated using an input device, and an application 120, which has the above-mentioned tab browser function. The application 120 is not limited to any particular one. While it is a tab browser in this embodiment, the application 120 may be any application, such as a document creation application, a spreadsheet application, a database application, a presentation application, or an integrated development environment, in other embodiments.

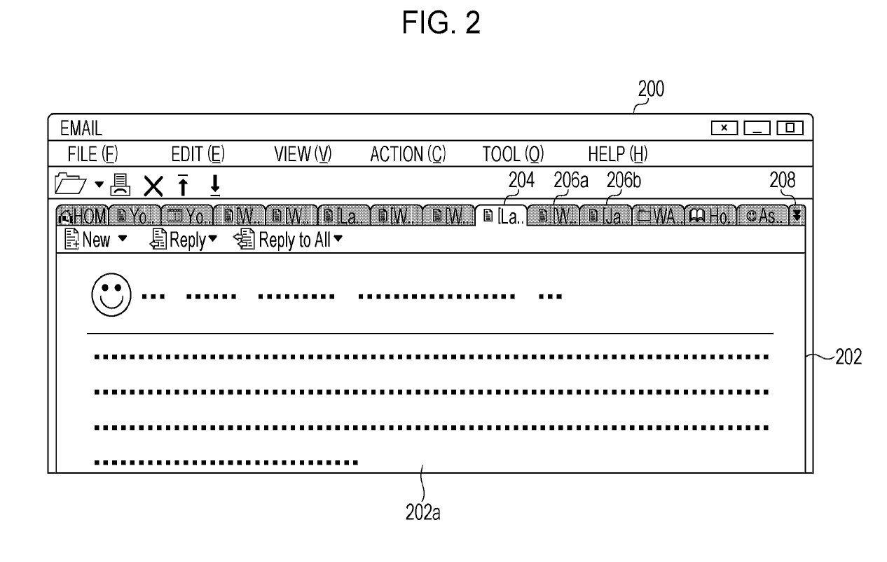

The application 120 according to this embodiment provides an application window 200 as illustrated in FIG. 2, providing a GUI-based operating environment to the operator of the computer apparatus 100. FIG. 2 illustrates an application window displayed on a display unit included in the computer apparatus 100 according to the first embodiment. A window 200 shown in FIG. 2 includes a tab-equipped view 202, which can change the display content by tab. The tab-equipped view 202 includes multiple tabs and can display one piece of content with respect to one tab on the window 200. Content displayed on the tab-equipped view 202 is not limited to any particular content and may be any content such as a Web page, email, document, spreadsheet, slide, memo, or address book. In this embodiment, the application window 200 serves as a display screen, and tabs 204 and 206 arranged on the window serve as objects.

The tabs are associated with pieces of content in the tab-equipped view 202. Selection of a tab displays content corresponding to the tab at a view area 202a. In FIG. 2, a tab 204 is currently active, and content corresponding to the active tab 204 is displayed in the view area 202a. In contrast, other tabs, tabs 206 (which are typified by tabs 206a and 206b in FIG. 2), are unselected, inactive tabs, and pieces of content corresponding to the inactive tabs 206 are not displayed.

A button 208 provided at the right end of the bar having the tabs 204 and 206 arranged thereon typifies one or more tabs which are undisplayed due to the limitation on the display area. A click of the button 208 develops items representing pieces of content corresponding to the omitted tabs in a pop-up manner so that any item can be selected. While this embodiment is described assuming that a click of the button 208 develops the items corresponding to the omitted tabs, the tab-equipped view 202 is not limited to this configuration. In another embodiment, scroll buttons may be provided at both ends of the bar having the tabs 204 and 206 so that the display range of the tabs is shifted using the scroll buttons.

Referring back to FIG. 1, the application 120 includes a view control unit 130, which controls the operation of the tab-equipped view 202 of the window 200 shown in FIG. 2. The view control unit 130 includes a change unit 132 and tab data 134. The tab data 134 is data for controlling the tabs of the tab-equipped view 202 and includes tab-related data, such as the label display text, display icons, tooltip text, and detailed data of the tabs, and, if required, a pointer to content itself.

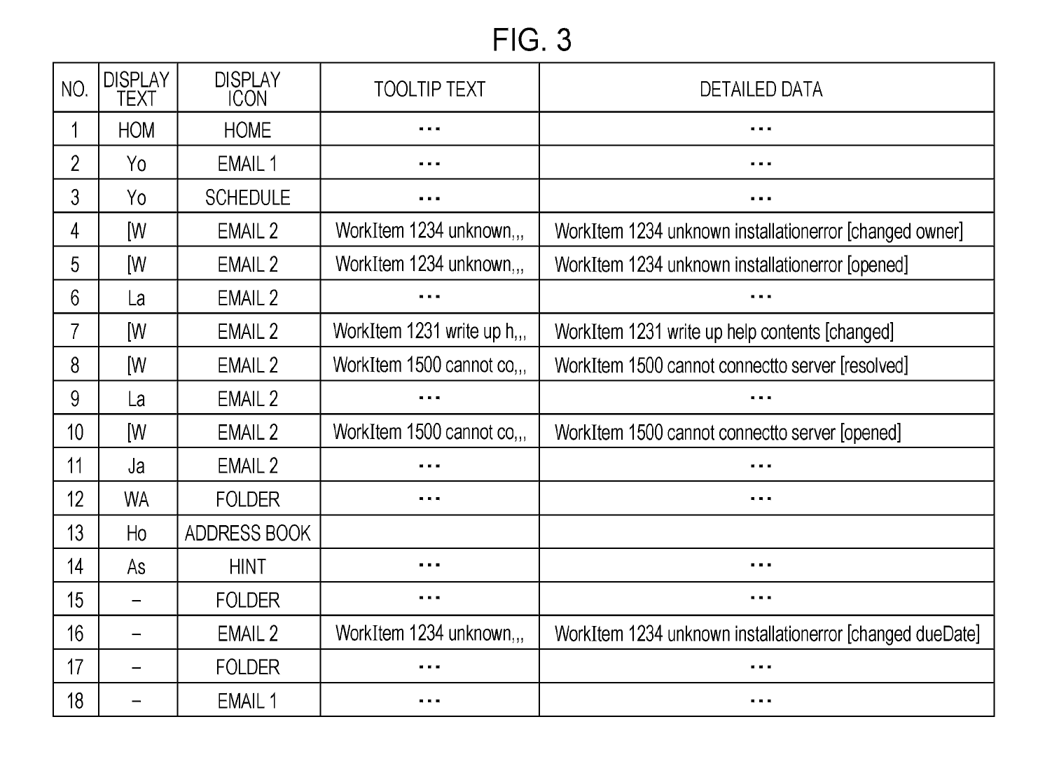

FIG. 3 illustrates the data structure of the tab data 134 stored in a storage unit of the computer apparatus 100 according to the first embodiment. As shown in FIG. 3, a record is generated for each tab. Each record includes a number for identifying a tab, display text displayed on the label of the tab, the display icon thereof, tooltip text prepared therefor, and detailed data thereof, but is not limited thereto.

The display text of a tab represents the title or the like of content corresponding to the tab. Typically, text following the number of displayable characters is omitted. The display icon of a tab represents the type of content corresponding to the tab. (In the display icon field of FIG. 3, a display icon is represented by an icon name.) Tooltip text is a simple description prepared for a tab. Detailed data includes a detailed description about content corresponding to a tab. Tooltip text may be, for example, the path to content, a tab assigned to content, or the title of content. Detailed data may be, for example, a summary of content, first some rows of sentences of content, or a preview image of content. Tabs having a value “-” in the display text field of the table shown in FIG. 3 correspond to the omitted tabs, which are not displayed in the window 200 shown in FIG. 2.

Referring back of FIG. 1, the change unit 132 is a function unit that controls usual change operations performed using tabs. When a particular operation (e.g., a click) is performed on one of the inactive tabs 206 arranged on the application window 200, the event detection unit 110 detects the operation event (e.g., the click event) performed on the inactive tab and sends a message indicating the detection to the change unit 132. Upon receipt of the message, the change unit 132 determines that the user has instructed the change unit 132 to directly select the inactive tab and considers the tab as a new active tab. It then allows the view area 202a to display the contents of a document corresponding to the tab.

When another particular operation (e.g., a mouseover) is performed on one of the tabs 204 and 206 with a change support function (to be described later) disabled, the event detection unit 110 detects the operation event (e.g., the mouseover event) performed on the tab and sends a notification indicating the detection to the change unit 132. Upon receipt of the notification, the change unit 132 obtains the tooltip text of the tab and allows the tooltip to pop up. Further, the change unit 132 performs on the tabs usual control operations such as close of a tab with a right click, an instruction to update a tab, and an instruction to copy a tab.

As described above, with regard to the display text of a tab, text following the number of displayable characters in the entire character string is generally omitted due to the limitation on the tab size. Accordingly, if a small number of pieces of content are opened, no significant problem arises. In contrast, if the number of pieces of content is large and tabs are densely packed in the display area, display character strings such as titles may not be displayed sufficiently, that is, only a few characters may be displayed. For example, if prefixes have the same title, the labels of tabs are displayed as completely the same character string. This may make the labels visually indistinguishable for the user.

For this reason, the view control unit 130 according to this embodiment further includes a change support unit 136, which has a change support function. When many pieces of content are opened, the user is thought to know the type and approximate location of the desired content even if the user does not correctly know to which tab the desired content corresponds. Using this characteristic of the user, the change support function according to this embodiment extracts tabs regarded as ones of the user's interest relative to a tab to which the user has pointed using a mouse by estimation and presents information about these tabs to the user. Thus, the change support function allows the user to select the desired tab efficiently.

In contrast, if a very few tabs are opened, a task such as sequential selection of the tabs or sequential pointing of the tabs with the mouse to check tooltip text is thought not to become a burden on the user. For this reason, the change support unit 136 according to this embodiment is enabled when the tab count is equal to or greater than a predetermined number.

When a particular operation (e.g., a mouseover) is performed on one of the tabs 204 and 206 arranged on the application window 200 shown in FIG. 2 with the change support function enabled, the event detection unit 110 detects the operation event generated on the tab (e.g., the mouseover event). The change support unit 136 receives a message indicating the detection and performs the change support process.

The change support unit 136 according to this embodiment includes an evaluation calculation unit 140, an extraction unit 142, and a pop-up control unit 144. The evaluation calculation unit 140 evaluates the similarity and the geometrical distance between tabs and calculates an evaluation value indicating the relatedness therebetween. An evaluation value indicating the relatedness between tabs can be calculated after a change support process is started when an operation event is performed on one of the tabs. In this case, the evaluation calculation unit 140 calculates the respective evaluation values between the tab in which the operation event has been detected and other tabs. Alternatively, evaluation values may be previously calculated when the status of the tabs in the tab-equipped view 202 is changed. In this case, the evaluation calculation unit 140 may previously calculate evaluation values with respect to all possible tab combinations and store the evaluation values in a storage unit.

The evaluation value is not limited to any particular type. A value obtained by comprehensively evaluating the similarity between tabs and the geometrical distance on the window 200 therebetween may be used as a comprehensive evaluation value. Alternatively, a similarity evaluation value, which is obtained by evaluating the similarity between tabs, and a distance evaluation value, which is obtained by evaluating the geometrical distance therebetween, may be separately calculated. The similarity evaluation value may be a specific evaluation value obtained by specifically evaluating the visual similarity between pieces of display texts or display icon images or a comprehensive evaluation value obtained by comprehensively evaluating the visual similarity between pieces of display texts and the visual similarity between display icon images. The similarity evaluation value may be calculated based on not only the visual similarity but also the similarity in an attribute not directly related to tab display, such as tooltips or detailed data in the tab data.

The similarity between pieces of display texts or pieces of texts contained in tooltips or pieces of detailed data may be evaluated using any measure for determining the similarity and commonality between pieces of text in information theory. Examples of such a measure include the edit distance (Levenshtein distance) between pieces of display text of tabs to be compared, the number of matches or mismatches between characters in pieces of display text, the similarity based on natural language processing such as morphological analysis or N-gram method, and the similarity based on the feature-value vectors of character strings.

The similarity between the above-mentioned display icon images or raster images included in tooltips or pieces of detailed data may be evaluated using a measure for determining the similarity and commonality between images in the image processing technology. Examples of such a measure include the sum of the color differences between images of both tabs and the similarity based on image feature-value vectors. The geometrical distance between objects such as tabs may be evaluated as the distance in pixels between the coordinates of the objects. If the objects are arranged in one dimension or two dimensions, the geometrical distance may be evaluated as the distance based on the positions in the arrangement.

The comprehensive evaluation value z(x, y) between any tab x and any tab y can be calculated using, but not limited to, Formula (1) or Formula (2) below. In Formulas (1) and (2) below, f(x,y) represents a similarity evaluation function for calculating a similarity evaluation value between the tabs x and y, and g(x,y) represents a distance evaluation function for calculating a distance evaluation value between the tabs x and y. Formula (1) below shows that the comprehensive evaluation value is calculated using an evaluation function defined as an average value of the sum of a similarity evaluation function and a distance evaluation function with respect to the particular tabs x and y. Formula (2) below shows that the comprehensive evaluation value is calculated using an evaluation function defined as the product of a similarity evaluation function and a distance evaluation function with respect to the particular tabs x and y. While the simple sum or product is described as an example combination of a similarity evaluation function and a distance evaluation function, any type of function such as a weighted sum may be used.

$$\begin{matrix}[ Formula 1 ] & \\ z ( x , y ) = \frac{f ( x , y ) + g ( x , y )}{2} & ( 1 ) \\ z ( x , y ) = f ( x , y ) \times g ( x , y ) & ( 2 )\end{matrix}$$

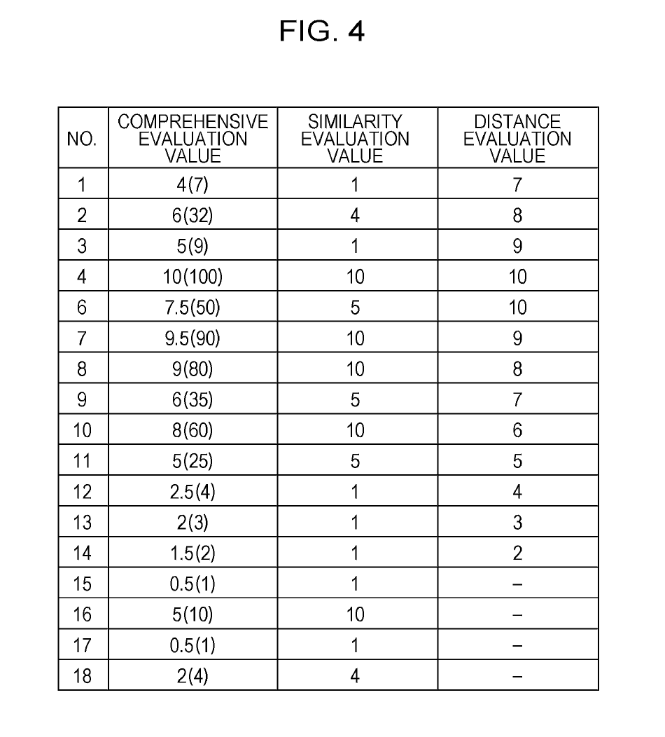

FIG. 4 illustrates the data structure of evaluation values calculated by the evaluation calculation unit 140 in the first embodiment. The example shown in FIG. 4 shows evaluation value data sets calculated between the fifth tab from the left and other tabs in FIG. 2. The evaluation value data sets shown in FIG. 4 are composed of records corresponding to the other tabs. Each record is composed of a number for identifying a tab, a comprehensive evaluation value, a similarity evaluation value, and a distance evaluation value.

The example of FIG. 4 indicates that a tab having a larger similarity evaluation value is more similar to the fifth tab and that a tab having a larger distance evaluation value is closer to the fifth tab. These mean that a tab having a larger comprehensive evaluation value has higher relatedness with the fifth tab. In FIG. 4, a comprehensive evaluation value represents a value calculated based on Formula (1) above, and a parenthesized value represents a value calculated based on Formula (2) above. In this embodiment, the distance evaluation value of an omitted tab, which is undisplayed, is not calculated, since the distance cannot be determined. On the other hand, the similarity evaluation value thereof is calculated using virtually displayed display text and display icon instead of the actual display text and display icon, since the omitted tab is undisplayed. In the calculation of the comprehensive evaluation value of an omitted tab, the distance evaluation value of the omitted tab in Formula (1) or Formula (2) above may be handled as the most distant value (for example, the minimum value 0 in Formula (1); the minimum value 1 in Formula (2)) or as a value equal to the similarity evaluation value. As seen, the omitted tab is also subjected to the evaluation value calculation. Accordingly, it is handled by the extraction unit 142 (to be described later).

Referring back to FIG. 1, when an operation event related to the window 200 is generated, that is, when a mouseover event on a tab is generated, the extraction unit 142 attempts to extract one or more tabs whose evaluation value relative to a tab directly related to the operation event meets a predetermined extraction condition. The above-mentioned tab directly related to the operation event will be referred to as “the tab of interest,” and the above-mentioned one or more tabs as “the related tabs.” The tab of interest is, for example, the tab on which the operation event has been detected, that is, the tab directly detected as a tab of the user's interest. On the other hand, the related tabs are tabs considered to be related to the tab of interest, in which the user is directly interested, and serve as candidates meeting the intent of the user.

The extraction condition is a condition for extracting related tabs which are related to the tab of interest, in which the user is directly interested, and which are desired to be presented as candidates to the user. It is not limited to any particular condition. For example, if the comprehensive evaluation value, which is obtained by comprehensively evaluating the similarity and geometrical distance between tabs, is given, the threshold of the comprehensive evaluation value or the lower limit of the ordinal ranks of the comprehensive evaluation values can be used as the extraction condition.

Alternatively, if the similarity evaluation value, the distance evaluation value, and an evaluation value for evaluating the similarity between tooltips, pieces of detailed data, or the like are separately given, the thresholds of the separate evaluation values or the lower limits of the ordinal ranks of the separate evaluation values may be used as the evaluation conditions. In this case, the extraction unit 142 can extract related tabs in stages with respect to the evaluation values. Further, an additional limiting condition such as exceptional tabs not to be extracted or the upper limit of the number of related tabs to be extracted may be added to the extraction condition. These extraction conditions are previously set as the basic setting of the application 120 by the user.

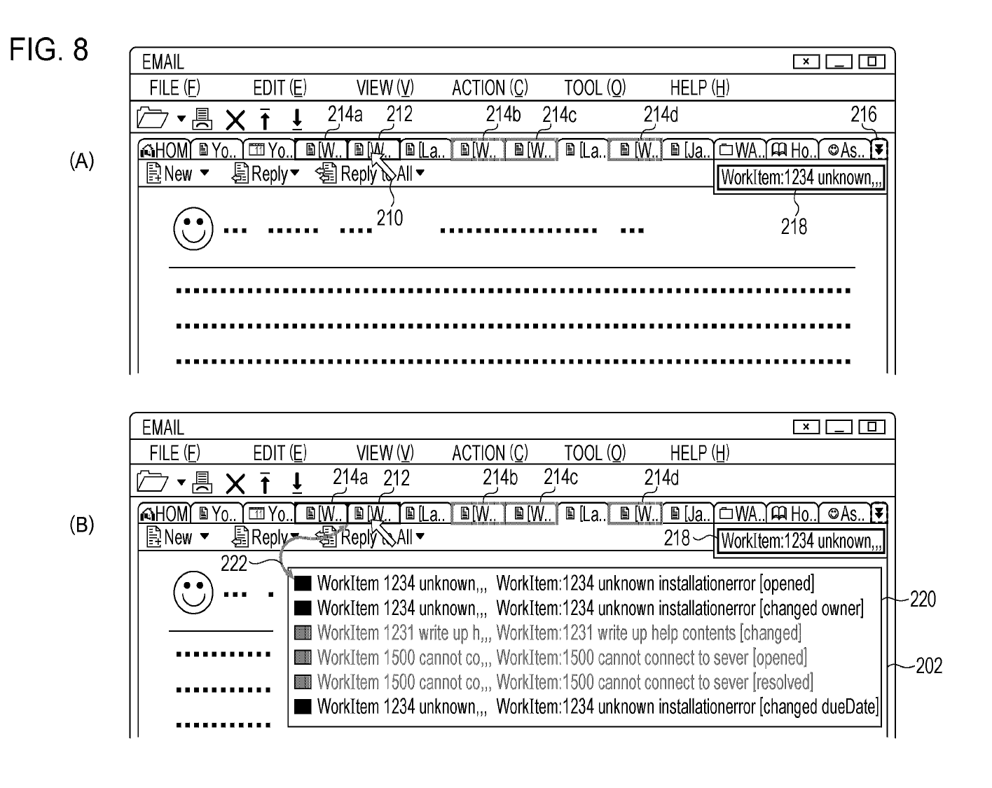

The pop-up control unit 144 reads respective pieces of presentation information prepared for the detected tab of interest and the extracted related tabs and displays the pieces of presentation information as a pop-up screen area closer to the user than the window 200 as shown in FIG. 8(B) so that the tabs and the pieces of presentation information are directly or indirectly visually associated with each other. The pop-up screen area is not limited to any particular type and may be a GUI which displays the respective pieces of presentation information of the tab of interest and the related tabs in an aligned manner so that any of the pieces of presentation information can be selected. The presentation information may be a tooltip or detailed data in the tab data 134.

FIG. 8 illustrates the application window 200 displayed on a display unit included in the computer apparatus 100 according to the first embodiment. FIG. 8(B) illustrates the window 200 having a pop-up screen area 220 listing the pieces of presentation information is displayed so that the pop-up screen area 220 is closer to the user than the tab-equipped view 202. In FIG. 8(B), a tab 212 is a tab of interest, and other highlighted tabs 214a to 214d and a popping-up omitted tab 218 are related tabs. The tab of interest 212 and the uppermost item in the pop-up screen area 220 are visually associated with each other by an arrowhead curve 222.

While a list box listing the respective pieces of presentation information of the tab of interest 212 and the related tabs 214a to 214d and 218 as list items is used as the pop-up screen area 220 in this embodiment, the pop-up screen area 220 is not limited thereto. In other embodiments, pieces of presentation information may be arranged in a matrix. Alternatively, the pop-up screen area 220 may be screen areas separately generated for the tab of interest and the related tabs.

Further, in order to bring differences between visually similar tabs into sharp relief and ensure that the user easily recognizes the differences between the tabs, the pop-up control unit 144 can identify the differences between the respective pieces of presentation information of the noted and related tabs and highlight the differences or commonalities.

Further, the pop-up control unit 144 can highlight the tab of interest 212 and the related tabs 214a to 214d, as shown in FIG. 8(B). If the omitted tab 218 is extracted as a related tab, it can be highlighted. A button 216 may also be highlighted. The pop-up control unit 144 also can highlight the related tabs 214 arranged on the window 200 using grayscales corresponding to both or one of the similarity evaluation value and the distance evaluation value. It also can sort the list items listed on the pop-up screen area 220 and representing the related tabs in accordance with both or one of the similarity evaluation value and the distance evaluation value.

The highlighting of the differences or commonalities or the highlighting using grayscales corresponding to both or one of the similarity evaluation value and the distance evaluation value can be carried out by changing at least one of the font, character decoration, character color, and font size of the applicable portions.

Further, when a confirmation operation is performed on one of the list items corresponding to the tab 212 and the related tabs 214a to 214d and 218 and displayed so that any one of the list items is selectable, the pop-up control unit 144 can notify the application 120 of the tab on which the confirmation operation has been performed and cause the application 120 to take an action for selecting that tab. Even when the pointer is detached from the tab of interest 212, the pop-up screen area 220 is continuously displayed until a predetermined cancellation condition is met. The list items are kept selectable during that period. The cancellation condition for cancelling the pop-up screen area 220 may be, for example, a lapse of a predetermined period of time or performance of an explicit operation by the user.

When a particular operation (e.g., a click) is performed on one of the pieces of presentation information listed on the pop-up screen area 220, the event detection unit 110 detects the operation event (click event) generated on the piece of presentation information. The change support unit 136 receives a notification indicating the detection. Upon receipt of the notification, the pop-up control unit 144 determines that a confirmation operation for selecting the corresponding tab has been performed and generates a confirmation operation (a click or a press of the enter key) on the tab. It then sends to the change unit 132 a notification indicating that the tab has been selected. Upon receipt of the notification, the change unit 132 changes the selected inactive tab to an active tab and displays the contents of a document corresponding to the tab on the view area 202a.

Further, when a particular operation event (e.g., a mouseover event) is generated on one of the related tabs 214a to 214d arranged on the window 200 or when a particular operation event (e.g., a mouseover event) is generated on one of the items representing the related tabs in the pop-up screen area 220, the pop-up control unit 144 can replace the arrowhead curve 222 connecting the tab 212 on the window 200 and the corresponding item in the pop-up screen area 220 with an arrowhead curve 222 connecting the related tab 214 on the window 200 and the corresponding item in the pop-up screen area 220. Thus, it can newly visually associate the related tab 214 and the corresponding item with each other.

The function units included in the computer apparatus 100 shown in FIG. 1 are realized by loading a program into the memory and executing the program under the control of the CPU to control the operation of hardware resources.

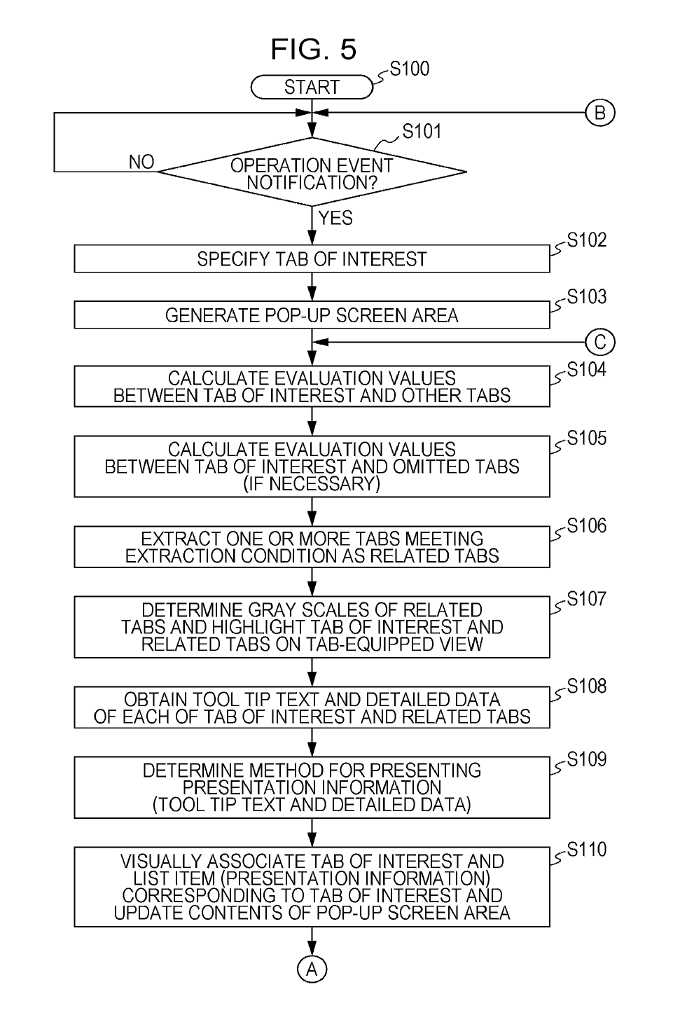

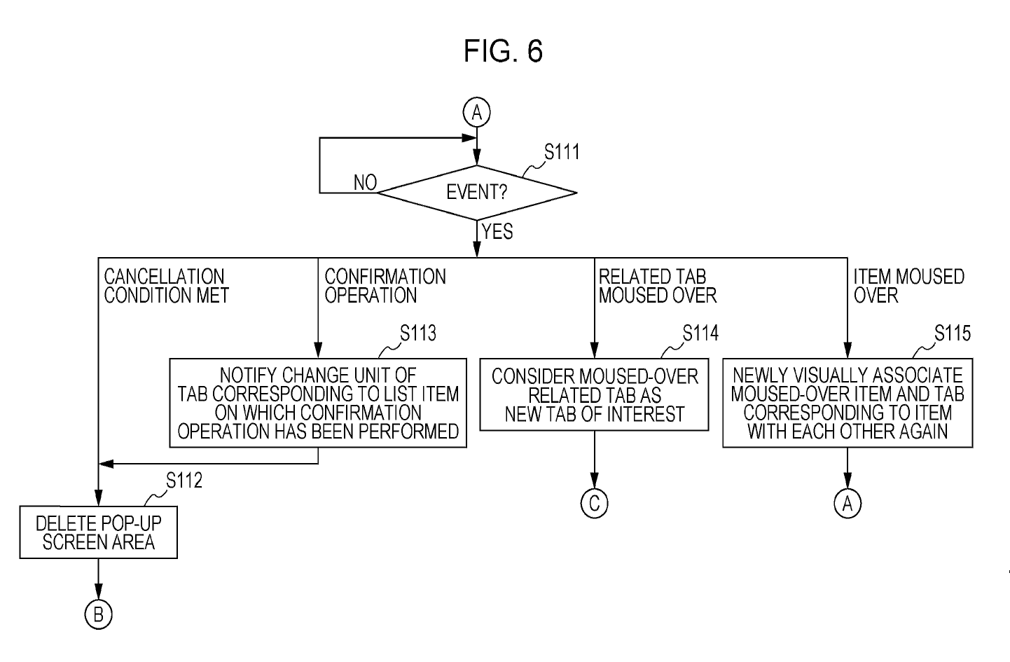

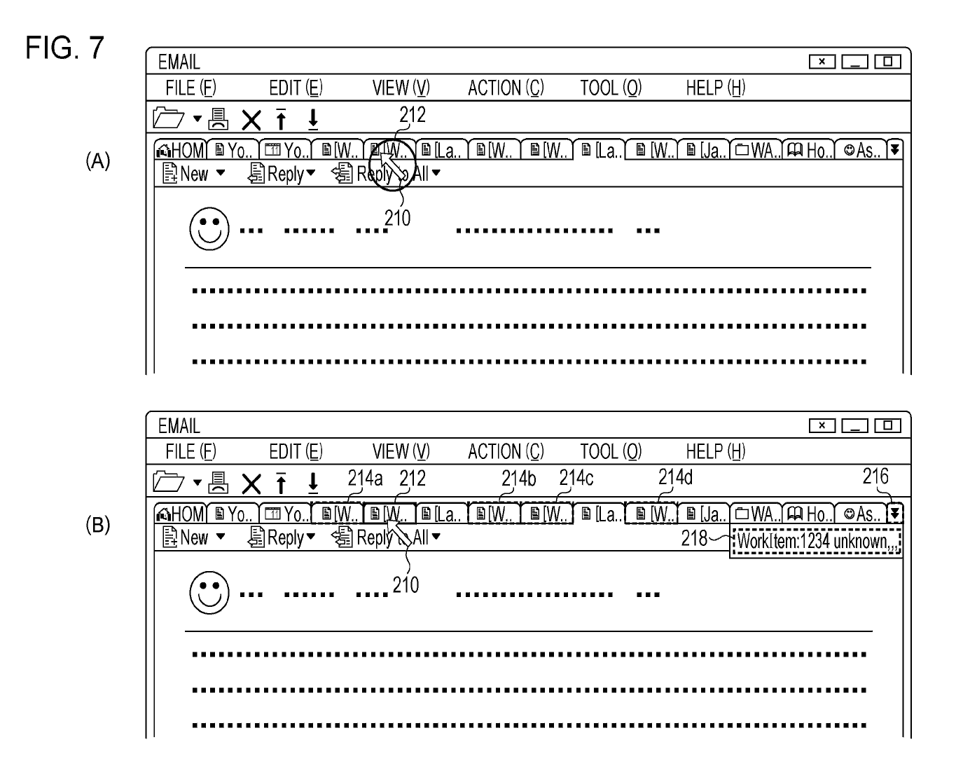

Hereafter, the change support process according to the first embodiment will be described in more detail with reference to the flowcharts shown in FIGS. 5 and 6 and the window screens shown in FIGS. 7 to 9. FIGS. 5 and 6 are flowcharts showing the change support process performed by the computer apparatus 100 according to the first embodiment. FIGS. 7 to 9 illustrate the application window 200 displayed on the display unit included in the computer apparatus 100 according to the first embodiment. The process shown in FIGS. 5 and 6 starts from step S100, for example, when a predetermined number or more of tabs are opened on the application window 200 so that the change support unit 136 is enabled.

In step S101, the change support unit 136 waits for a notification indicating a particular operation event from the event detection unit 110. It loops step S101 until it receives such an operation event (NO period). When a mouse pointer 210 is overlaid on the tab 212 in the window 200 in step S101 as shown in FIG. 7(A) so that the change support unit 136 is notified that a mouseover event has been generated on the tab 212 (YES), the process proceeds to step S102.

In step S102, the change support unit 136 identifies a tab of interest directly related to the operation event (the tab 212 in FIG. 7(A)) in accordance with the notification from the event detection unit 110. In step S103, the change support unit 136 generates objects of the pop-up screen area. In step S104, the evaluation calculation unit 140 calculates evaluation values between the tab of interest and other tabs on the window 200. In step S105, the evaluation calculation unit 140 calculates evaluation values between the tab of interest and omitted tabs, if required.

In step S106, the extraction unit 142 extracts one or more tabs whose evaluation value relative to the tab of interest meets the extraction condition, from among the other and omitted tabs as related tabs. In this embodiment, related tabs are extracted through a three-stage extraction process: in the first stage, tabs whose evaluation value obtained by evaluating the similarity between pieces of display text is equal to or greater than a predetermined value are extracted; in the second stage, tabs whose evaluation value obtained by evaluating the similarity between pieces of tooltip text are equal to or greater than a predetermined value are extracted; and in the third stage, tabs whose evaluation value obtained by evaluating the similarity between pieces of detailed data is equal to or greater than a predetermined value are extracted. In the example shown in FIG. 7(B), the related tabs 214a to 214d of the displayed tabs and the omitted tab 218 of the omitted tabs are extracted as related tabs.

In step S107, the pop-up control unit 144 determines the grayscales of the related tabs and highlights the tab of interest 212 and the related tabs 214a to 214d and 218 on the tab-equipped view 202 using gradual grayscales, as shown in FIG. 8(A). In FIG. 8(A), the tab 214a adjacent to the tab 212 and the omitted tab 218 are highlighted using a frame having a color more dense than that of the other related tabs 214b to 214d. The method for highlighting a tab is not limited to any particular one and may be thickening of a frame or changing of the tab size.

In step S108, the pop-up control unit 144 obtains respective tooltips and pieces of detailed data of the tab of interest and the related tabs from the tab data 134. In step S109, the pop-up control unit 144 determines the method for presenting the presentation information (tooltip text and detailed data). Examples of the presentation method include the grayscales used to highlight the list items, the order in which the list items are arranged, and the method for highlighting the differences in tooltip and detailed data between the tabs.

In step S110, the pop-up control unit 144 visually associates the tab of interest 212 and the list item corresponding to the tab of interest on the pop-up screen area 220 with each other using the arrowhead curve 222, as shown in FIG. 8(B). It also updates the content displayed on the pop-up screen area 220. In the example shown in FIG. 8(B), the listed pieces of presentation information are sorted in accordance with the distances between the corresponding related tabs and the tab of interest with the tab of interest 212 located at the top. Further, the presentation information of the tab of interest 212 and the pieces of presentation information of the highlighted tabs 214a and 218 are highlighted using the filling color of the left box, the font, and character decoration.

After the process of step S110 is complete, the process proceeds to step S111 shown in FIG. 6 through a point A. In step S111, the pop-up control unit 144 waits until a particular event occurs. It loops step S111 before such an event occurs (NO period). When such an event occurs in step S111, the process is branched in accordance with the event.

If an event where the condition for cancelling the pop-up screen area 220 is met (meeting of the cancellation condition) occurs in step S111, the process proceeds to step S112. The cancellation condition is met when a predetermined time has elapsed in a state where another particular event does not occur or when the user performs a predetermined, explicit operation, such as a click of the view area 202a, a click of the escape button, or activation of the window of another application so that the window 200 is inactivated. In step S112, the change support unit 136 deletes the objects in the pop-up screen area 220 and returns to step S101 shown in FIG. 5 through a point B. In this case, the change support unit 136 waits until a particular operation event occurs on the next tab.

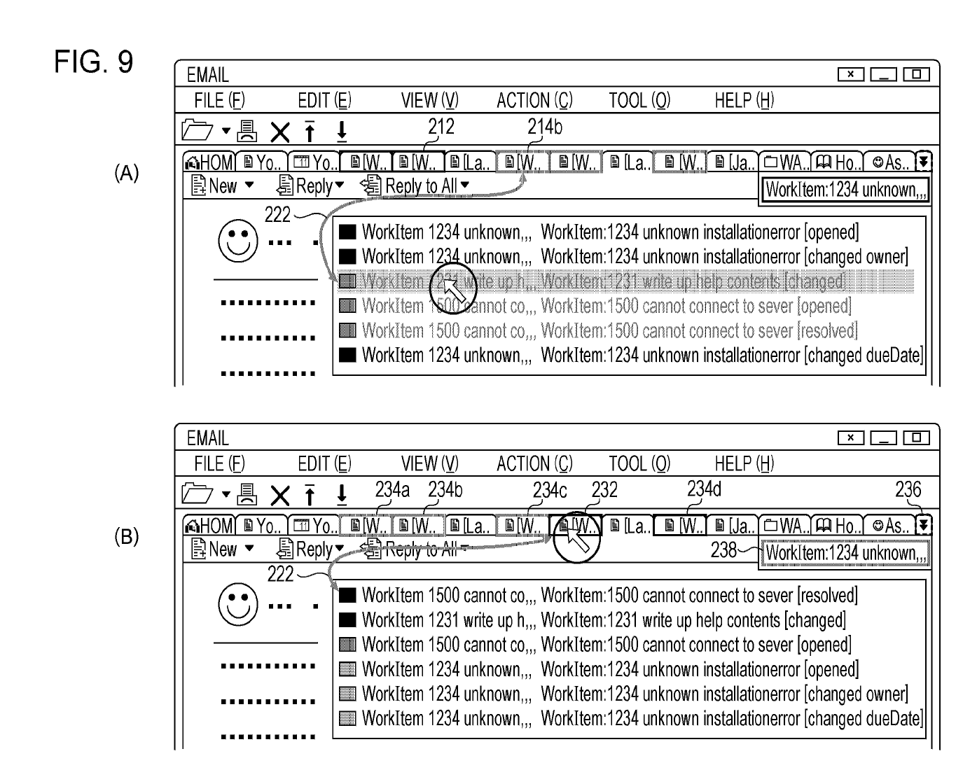

In contrast, if a confirmation operation event such as a click of one of the list items in the pop-up screen area 220 occurs in step S111 as shown in FIG. 9(A) (confirmation operation), the process proceeds to step S113. In step S113, the change support unit 136 notifies the change unit 132 of a tab corresponding to the list item on which the confirmation operation has been performed. This tab is activated and content corresponding to the tab is displayed in the view area 202a.

If a mouseover event on one of related tabs 232 and 234a to 234d of the tab-equipped view 202 occurs in step S111 as shown in FIG. 9(B) (a mouseover on a related tab), the process proceeds to step S114. In step S114, the pop-up control unit 144 considers the currently moused-over related tab 232 as a new tab of interest. The process is branched to step S104 shown in FIG. 5 through a point C. In this case, evaluation values between the currently moused-over, new tab of interest 232 and other tabs are calculated in steps S104 and S105. In step S106, new related tabs 234a to 234d and 238 are extracted. In step S110, the content on the pop-up screen area 220 is updated. As seen, the pop-up control unit 144 can update the pop-up screen area 220 when the tab of interest is changed during a period from the meeting of the cancellation condition to the disappearance of the pop-up screen area 220.

If a mouseover event occurs on a particular list item in the pop-up screen area 220 as shown in FIG. 9(A) in step S111 (a mouseover on an item), the process proceeds to step S115. In step S115, the pop-up control unit 144 replaces the previous arrowhead curve 222 with an arrowhead curve 222 connecting the currently moused-over list item and a related tab or tab of interest corresponding to the list item, newly visually associating the currently moused-over list item and the corresponding related tab or tab of interest. The process is branched to step S111 through the point A.

According to the above-mentioned first embodiment, even when a large number of pieces of content are opened and the display icons and the pieces of display text of multiple tabs densely packed in the display area are identical or extremely similar to each other so that they are visually indistinguishable, the user can find the desired tab efficiently using the change support function. That is, when the user points to a tab by estimation, a group of related tabs which are visually similar to the tab of interest and geometrically adjacent thereto are extracted. Then, pieces of information about these tabs are presented to the user. Accordingly, the user can find a tab corresponding to the desired content efficiently.

For example, when many search results obtained using the same search engine or many Web pages of the same site are opened on a Web browser or when many emails having a title having a particular prefix are opened on a mailer, work burdens such as selecting of the tabs one-by-one and pointing of the tabs using a mouse one-by-one to check tooltip text are favorably reduced.

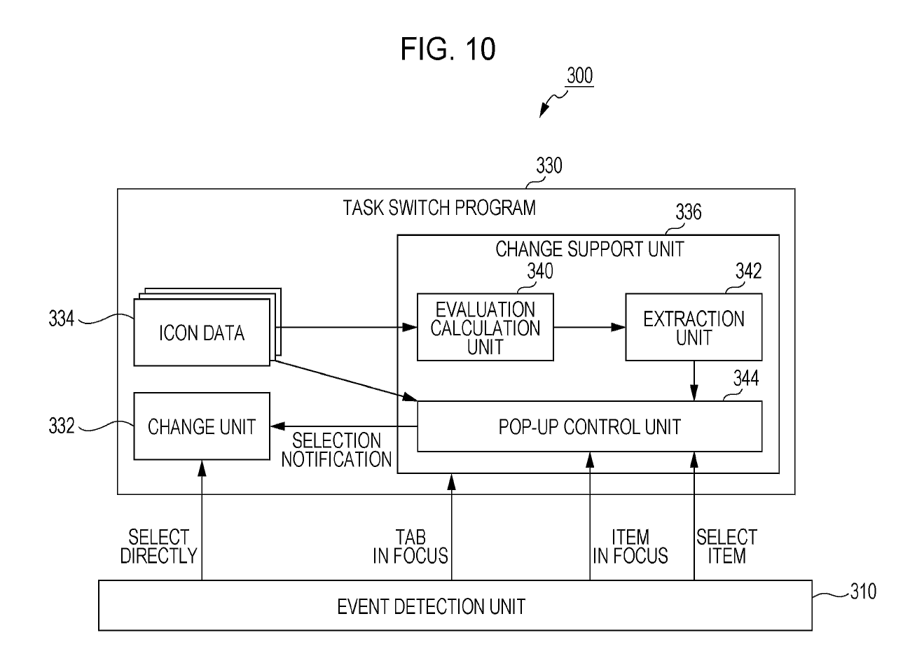

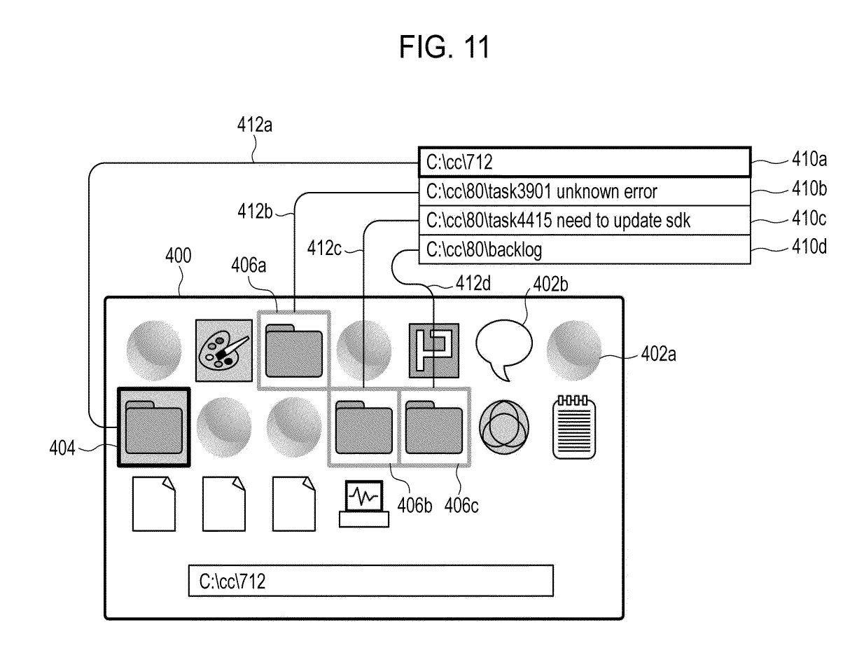

While the tab-equipped view of various GUI controls has been described as an example in the first embodiment, the present invention is applicable to any other GUI controls such as tree views and list views. While the change support function has been described as a function unit incorporated into the application 120 in the first embodiment, this change support function can be applied to multiple applications, for example, so that common tabs and icons are listed on both a mailer and a Web browser which are running, in other embodiments. Alternatively, the change support function may be realized using not only a GUI control of a particular application but also the task switch function of a GUI-based desktop environment. Hereafter, a change support function according to a second embodiment of the present invention will be described with reference to FIGS. 10 and 11.

### Second Embodiment

Since the second embodiment has a configuration common to that of the above-mentioned first embodiment, the differences between the embodiments will be described mainly. Similar function units have reference numerals whose first digit is three and whose last two digits are the same numbers as those in the first embodiment.

FIG. 10 shows function blocks of a computer apparatus 300 according to the second embodiment. As in the first embodiment, the function blocks of the computer apparatus 300 according to the second embodiment include an event detection unit 310, which detects an operation event generated using an input device, and a task switch program 330.

The task switch program 330 according to this embodiment provides a task switch screen 400 as illustrated in FIG. 11. The user can efficiently change the window using the task switch screen 400. FIG. 11 illustrates the task switch screen 400 displayed on a display unit included in the computer apparatus 300 according to the second embodiment. Multiple icons 402a and 402b are two-dimensionally arranged on the task switch screen 400 shown in FIG. 11. In this embodiment, the task switch screen 400 serves as a display screen, and the icons 402 arranged on the task switch screen 400 serve as objects.

The icons 402 on the task switch screen 400 and application windows to be changed are associated with each other. Selection of one of the icons 402 activates the application window corresponding to the selected icon. The application windows are units of the window of a single document interface (SDI) application or units of the window of an MDI or TDI application and are associated with the icons. (The units may be units of a child window) A highlighted icon 404 in FIG. 11 is an icon of interest in focus. Other highlighted icons 406a to 406c are related icons considered to be related to the icon of interest 404.

Referring back to FIG. 10, more specifically, the task switch program 330 includes a change unit 332, icon data 334, and a change support unit 336. The change unit 332 is a function unit that controls a usual change operation based on selection of an icon. The icon data 334 is data for controlling the icons and is storing information about the icons, such as the display icons, the pieces of tooltip text, and the pieces of detailed data of the icons.

When the enter key is pressed with any icon arranged on the task switch screen 400 in focus or when such an icon is clicked, the event detection unit 310 detects the click operation or enter operation performed on the icon and sends a message indicating the detection to the change unit 332. Upon receipt of the message, the change unit 332 determines that the user has instructed the change unit 332 to directly select the icon and activates a window corresponding to the icon.

When the focus is moved to one of the icons 402 (which are typified by icon 402a and 402b in FIG. 11) arranged on the task switch screen 400 shown in FIG. 11 or the mouse pointer is overlaid on the icon, the event detection unit 310 notifies the change support unit 336 of the operation event, which is a focus or mouseover on the icon. Upon receipt of the notification, the change support unit 336 performs a change support process.

As in the first embodiment, the change support unit 336 includes an evaluation calculation unit 340, an extraction unit 342, and a pop-up control unit 344. When the operation event related to the task switch screen 400, that is, the operation event, which is a focus or mouseover on the icon, occurs, the extraction unit 342 extracts one or more icons whose evaluation value relative to an icon directly related to this operation event meets a predetermined extraction condition. The icon directly related to this operation event will be referred to as “the icon of interest,” and the one or more icons as “the related icons.” The same condition as that in the first embodiment can be used as the extraction condition.

The pop-up control unit 344 reads respective pieces of presentation information prepared for the detected icon of interest and the extracted related icons and displays the pieces of presentation information as multiple pop-up screen areas 410a to 410d closer to the user than the task switch screen 400 as shown in FIG. 11 so that the icons and the pieces of presentation information are directly or indirectly visually associated with each other. In FIG. 11, the pop-up screen areas 410a to 410d are generated for the icon of interest and the related icons. The pop-up screen areas and the icon of interest and the related icons are visually associated with each other by curves 412a to 412d.

The differences between the pieces of texts of the icons in the pop-up screen areas 410 shown in FIG. 11 are highlighted in boldface type. Thus, the differences between the visually similar icons are brought into relief and displayed so that the user can easily recognize the differences.

Further, when a confirmation operation such as a click is performed on one of the items representing the icon of interest and the related icons and displayed so that one of the items are selectable, the pop-up control area 344 can activate a window corresponding to the item on which the confirmation operation has been performed.

As described above, according to this embodiment, it is possible to provide an information processing apparatus, a display processing method, a program, and a storage medium that can present information desired by the user efficiently by extracting objects considered to be of the user's interest from among many objects such as tabs or icons arranged on the display screen and presenting pieces of information about the objects and thus can favorably prevent a reduction in user convenience caused by the placement of many objects on the display screen.

The functions of the present invention can be realized by a device-executable program written in an object-oriented programming language such as C++, Java®, Java® Beans, Java® Applet, Java® Script, Perl, or Ruby. Such a device-executable program can be stored in a device-readable storage medium and distributed or transmitted and then distributed.

While the present invention has been described using the particular embodiments, the invention is not limited thereto. Changes such as additions and deletions can be made thereto or other embodiments can be employed without departing from the scope conceivable for those skilled in the art. Any aspects will fall within the scope of the present invention as long as the aspects exhibit the advantageous effects of embodiments of the invention.

We claim:

1. An information processing apparatus on which software runs, the software including a display screen as a user interface, the display screen having a plurality of objects arranged thereon, the information processing apparatus comprising:
a calculation unit that calculates an evaluation value, the evaluation value being obtained by evaluating similarity between the objects and a distance on the display screen therebetween;
an extraction unit that, in response to generation of an operation event related to the display screen using an input device, extracts one or more objects whose evaluation value relative to an object of interest directly related to the operation event meets an extraction condition, from the display screen as related objects; and
a display control unit that displays respective pieces of presentation information prepared for the object of interest and the related objects as a screen area closer to a user than the display screen on a display unit so that the pieces of presentation information are visually associated with each other.

2. The information processing apparatus according to claim 1, wherein the display control unit displays the respective pieces of presentation information of the object of interest and the related objects in an aligned manner on the screen area while clearly showing differences between the pieces of presentation information.

3. The information processing apparatus according to claim 2, wherein the display control unit displays the object of interest and the related objects as items so that one of the items can be selected and, when a confirmation operation is performed on one of the items, notifies the software of an object corresponding to the item on which the confirmation operation has been performed.

4. The information processing apparatus according to claim 3, wherein the display control unit highlights the related objects arranged on the display screen using gray scales according to both or one of the similarity and the distance, as well as displays the items listed on the screen area and representing the related objects so that the items are sorted by both or one of the similarity and the distance.

5. The information processing apparatus according to claim 4, wherein when an operation event is generated on one of the related objects on the display screen before a cancellation condition is met so that the screen area disappears, the extraction unit again extracts the related object directly related to the operation event as a new object of interest, and the display control unit updates the contents of the screen area.

6. The information processing apparatus according to claim 5, wherein when an operation event is generated on one of the related objects arranged on the display screen or when an operation event is generated on one of the items representing the related objects in the screen area, the display control unit newly visually associates the item representing the related object in the screen area and the related object arranged on the display screen with each other.

7. The information processing apparatus according to claim 6, wherein the display screen includes an object associated with one or more omitted objects, the one or more omitted objects being undisplayed on the display screen, and
the extraction unit further extracts one or more omitted objects as related objects, the one or more omitted objects having an evaluation value meeting a condition, the evaluation value being obtained by evaluating at least similarity to the object of interest.

8. The information processing apparatus according to claim 7, wherein the display control unit is enabled when the number of objects arranged on the display screen exceeds a predetermined value.

9. The information processing apparatus according to claim 1, wherein the similarity between objects is calculated using a similarity evaluation function, the similarity evaluation function being used to evaluate similarity defined with respect to at least one of display text, a display image, and description data of each object, and
the distance on the display screen between objects is calculated using a distance evaluation function, the distance evaluation function being used to evaluate a geometrical distance defined with respect to the position in which each object is arranged on the display screen, and
the evaluation value is calculated using a function, the function being obtained by combining the similarity evaluation function and the distance evaluation function.

10. The information processing apparatus according to claim 1, wherein the pieces of presentation information each include text, and differences between the objects are highlighted by changing the font, character decoration, or character color of differences or commonalities between the pieces of texts.

11. A display processing method performed by an information processing apparatus on which software runs, the software including a display screen as a user interface, the display screen having a plurality of objects arranged thereon, the display processing method comprising:
detecting an operation event related to the display screen generated by an input device;
calculating respective evaluation values between an object of interest, the object of interest being one of the objects and directly related to the operation event, and the others of the objects, the evaluation values each being obtained by evaluating similarity between objects and a distance on the display screen therebetween, and extracting one or more objects whose evaluation value meets an extraction condition, as related objects; and displaying respective pieces of presentation information prepared for the object of interest and the related objects as a screen area closer to a user than the display screen on a display unit so that the pieces of presentation information are visually associated with each other.

12. The information processing apparatus according to claim 11, wherein the displaying step comprises:
identifying differences between the respective pieces of presentation information of the object of interest and the related objects; and
displaying the identified differences on the screen area in an aligned manner while clearly showing the different locations.

13. A computer readable storage medium comprising a set of instructions for realizing an information processing apparatus on which software runs, the software including a display screen as a user interface, the display screen having a plurality of objects arranged thereon, which, if executed by a processor, cause a computer to:
calculate an evaluation value, the evaluation value being obtained by evaluating similarity between objects and a distance on the display screen therebetween;
extract, when an operation event related to the display screen is generated using an input device, one or more objects whose evaluation value relative to an object of interest directly related to the operation event meets an extraction condition, from the display screen as related objects; and
display respective pieces of presentation information prepared for the object of interest and the related objects as a screen area closer to a user than the display screen on a display unit so that the pieces of presentation information are visually associated with each other.
